(19) United States
(12) Patent Application Publication
(10) Pub. No.: US 2005/0264016 A1
(43) Pub. Date: Dec. 1, 2005

(54) Scoop with bag for animal waste

(76) Inventor: Sherri L. Davis, Oakville (CA)

Correspondence Address: BERESKIN AND PARR, 40 KING STREET WEST, BOX 401, TORONTO, ON, M5H 3Y2, CA

(21) Appl. No.: 10/856,791

(22) Filed: Jun. 1, 2004

(51) Int. Cl. A01K 29/00; E01H 1/12

(52) U.S. Cl. 294/1.3

(57) ABSTRACT

An apparatus for picking up animal feces or other garbage has a scoop with an inner surface defining a cavity. A receptacle adapted to hold a bag within the interior of the receptacle is attached to the scoop. A passageway between the interior of the receptacle and the interior of the cavity of the scoop allows the open end of a bag to be pulled into the cavity through a wall of the scoop. The open end of the bag is folded over the edge of the scoop. The closed end of the bag is held in or to the passageway either directly or through a second bag detachably connected to the first bag. The feces or other garbage may be picked up in the scoop and the open end of the bag tied to enclose it. The bag may then be removed for disposal.

### FIELD OF THE INVENTION

This invention relates to devices or processes for picking up or disposing of animal feces or other garbage.

### BACKGROUND OF THE INVENTION

Most municipalities require pet owners to pick up and dispose of their animal's feces, at least in public areas. One common method of doing this is to invert a plastic bag over the hand, lift the feces into the bag with the plastic covered hand and then re-invert the bag over the feces. This avoids touching the feces directly, but requires touching the feces through the bag which still disgusts the typical pet owner. Instead, some pet owners use a mechanical scoop of some kind to pick up the feces. While avoiding touching the feces, the scoop becomes dirty and has to be cleaned which still disgusts the typical pet owner.

### SUMMARY OF THE INVENTION

This invention provides an apparatus and process for picking up animal feces or other garbage. The invention further provides an apparatus and process for bagging feces or other garbage for disposal. These objects may be accomplished without having to touch the feces or garbage, even through the bag, and without the apparatus contacting the feces or garbage and getting dirty. The following summary is intended to introduce the reader to the invention which may reside in a combination or sub-combination of one or more elements or steps described below or in other parts of this document.

In one aspect, the invention provides a scoop and a receptacle for holding a bag or a roll of bags releasably held together, for example by a line of serrations. The receptacle may be attached, optionally releasably, to the outside of the scoop and function as a handle. However, a hole or passageway connects the inside of the receptacle to a hollow cavity defined by the inner surface of the scoop. The surface of the scoop may be solid or discontinuous, as in a mesh, grid or perforated surface. The hole or passageway allows the open end of a bag to be pulled from the receptacle into the scoop cavity. The open end of the bag may then be folded back over the edge of the scoop so that the inner surface of the scoop is covered by the bag. The closed end of the bag may remain in the passageway or be detachably connected to a second bag in the passageway or receptacle. Friction or mechanical resistance between the passageway and the bag, or the second bag, opposes movement of the bag through the passageway. In this way, the closed end of the bag is releasably held in the cavity of the scoop. This makes the step of folding the open end of the bag over the edge of the scoop easier since it stabilizes the bag. Further, since both ends of the bag are held, the open end by being folded over the edge of the scoop and the closed end directly or indirectly by the passageway, the bag does not fall out of the scoop. This effect is enhanced if the passageway is located away from the edge or near the bottom of the cavity of the scoop. After feces or other garbage is scooped into the scoop cavity, the open end of the bag is folded back over to enclose the feces or garbage and tied shut. The bag can then be pulled out of the scoop, detached from the next bag in the roll if applicable, and thrown away.

Other aspects of the invention will become apparent from the embodiments described below the summary or are described in the claims.

### BRIEF DESCRIPTION OF THE DRAWINGS

Embodiment(s) of the invention will be described below with reference to the following figures:

FIG. 1 is a pictorial view of an embodiment with a small discontinuous scoop.

FIG. 2 is a pictorial view of an embodiment with a large solid surfaced scoop.

FIG. 3 is an exploded pictorial view of an embodiment having a medium sized discontinuous scoop.

FIG. 4 is a pictorial view of an embodiment having a light.

FIG. 5 shows steps in using an embodiment of the invention to pick up animal feces or other garbage.

### DETAILED DESCRIPTION OF THE EMBODIMENT(S)

The Figures show various embodiments of an apparatus 10 for picking up animal feces or other garbage. The apparatus 10 has a scoop 12 connected to a receptacle 14. The receptacle 14 optionally, for example as in the embodiments shown, functions as a handle for the scoop 12. The receptacle 14 may also have an optional clip 16 to allow the apparatus 10 to be attached to a belt, leash or other object.

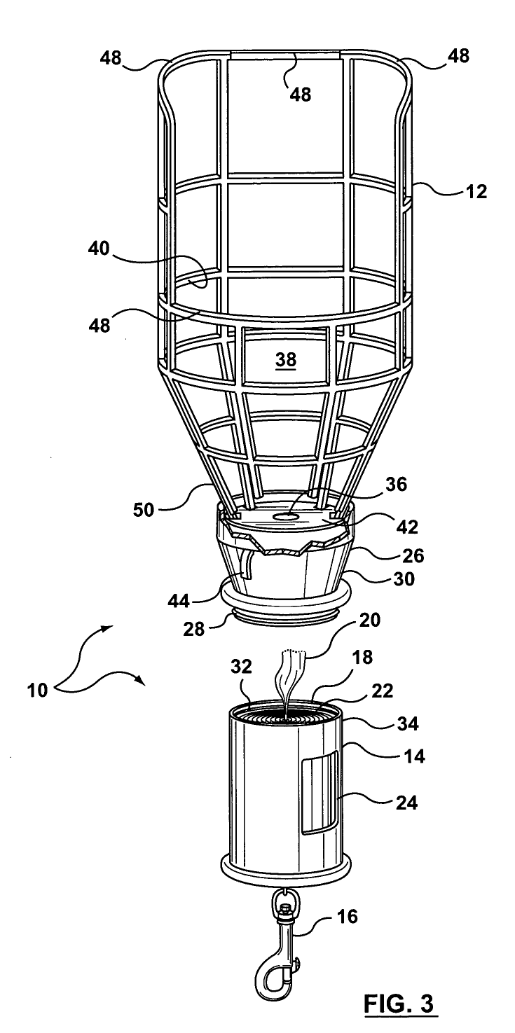

As best seen in FIG. 3, the receptacle 14 has a hollow interior 18 that may be filled with one or more bags 20. For example, the receptacle 14 may be filled with a roll 22 of a plurality of bags 20. The bags 20 in the roll 22 may be releasably connected together end to end, for example by a line of serrations. The roll 22 has a first end that is an open end of a first bag 20 and a second end that is a closed end of a last bag 20. The bags 20 are connected closed end to open end in a line with the closed end of a preceding bag 20 connected to an openable end of a following bag 20. When the first bag 20 is ripped from the roll 22, by tearing across the serrations, the following bag 20 is opened. The roll 22 may be rolled such that the first end of the roll is in the middle of the roll 22. In this way, bags 20 may be pulled out of the roll 22 and the receptacle 14 generally along an extension of an axial centerline of the receptacle 14 or roll 22. A window 24 in the wall of the receptacle 14 allows a visual check of whether, and roughly how many, bags 20 are in the receptacle 14. The strip of bags 20 may be folded one or more times lengthwise before being rolled to reduce the height of the roll 22.

The receptacle 14 may be attached to the scoop 22 through a base 26 of the scoop 12. The base 26 may be a distinct part, as illustrated, or it may be an integral feature or part of the rest of the scoop 12. The base 26 may also have a ridge 28 around its free end 30. The ridge 28 snap fits into a groove 32 in an open end 34 of the receptacle 14 when the free end 30 of the base 26 is inserted into the open end 34 of the receptacle 14. In this way the receptacle 14 may be alternately attached or released from the scoop 12. This allows for filling the receptacle 14 with a new roll 22 of bags 20 through the open end 34 of the receptacle 14 when required. In place of the snap fit, the receptacle 14 and base 26 could be modified such that one screws into the other, or fasteners or other means are used to attach them. Alternately, the receptacle 14 may be permanently attached to the scoop 12 or even integral with the scoop 12 and another opening for access provided to allow filling the receptacle 14 with bags 20.

A passageway 36 permits a bag 20 pulled from the interior of the receptacle 14 to travel through a wall of the scoop 12 into a cavity 38 defined by the inside surface 40 of the scoop 12. As illustrated, the passageway 36 may be a simple hole. The passageway 36 may be formed in a wall of the scoop 12 generally, in a wall of the base 26 part of the scoop 12 or in a plate 42 attached to either the scoop 12, base 26 (as illustrated) or both. The plate 42 may be releasably attached by a snap fit to the scoop 12 and form a part of the wall of the scoop 12 when attached. In this way, the plate 42 may be detached from the scoop 12 to aid in threading bag 20 through the passageway 36 after which step the plate 42 is snapped back in place in the scoop 12.

The passageway 26 may be sized to provide a slight mechanical or frictional resistance to a bag passing through it. In this way, the passageway 36 may lightly hold a part of a bag 20 in the passageway 36 either directly or by holding a following bag 20 in the roll 22. The bags 20 typically emerge from the passageway 36 in a twisted or elongated form that may be temporarily held in a hook 44. The hook 44 may also be used to hold a bag 20 filled with feces or other garbage until the bag 20 can be thrown away.

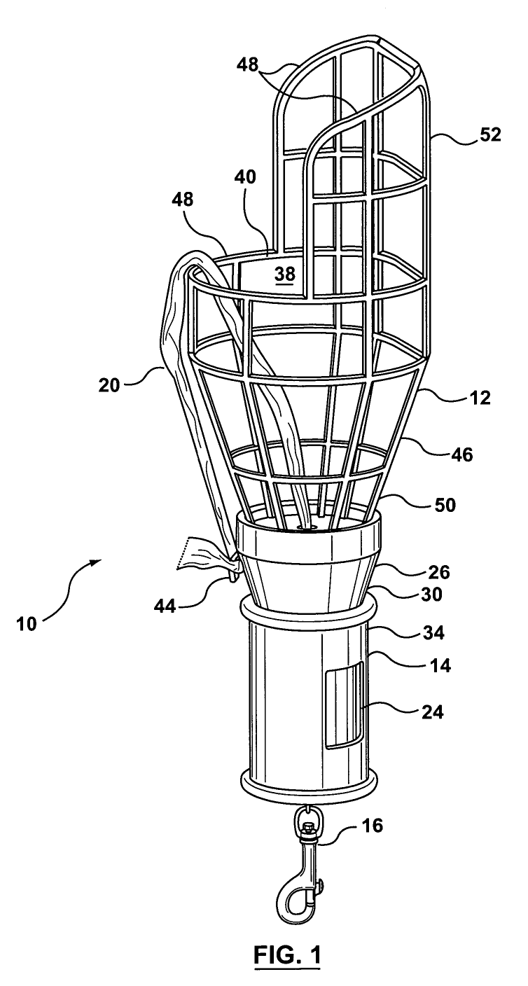

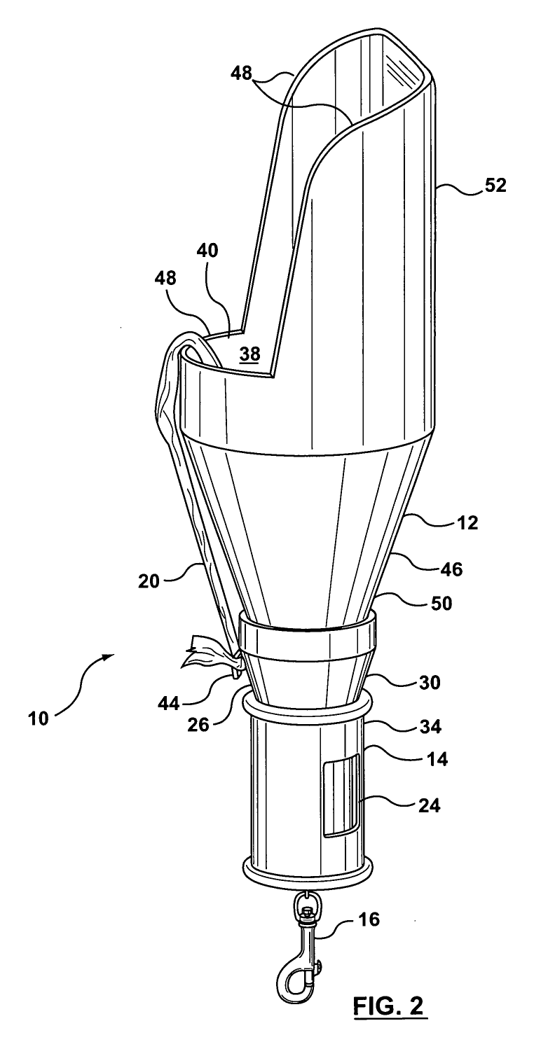

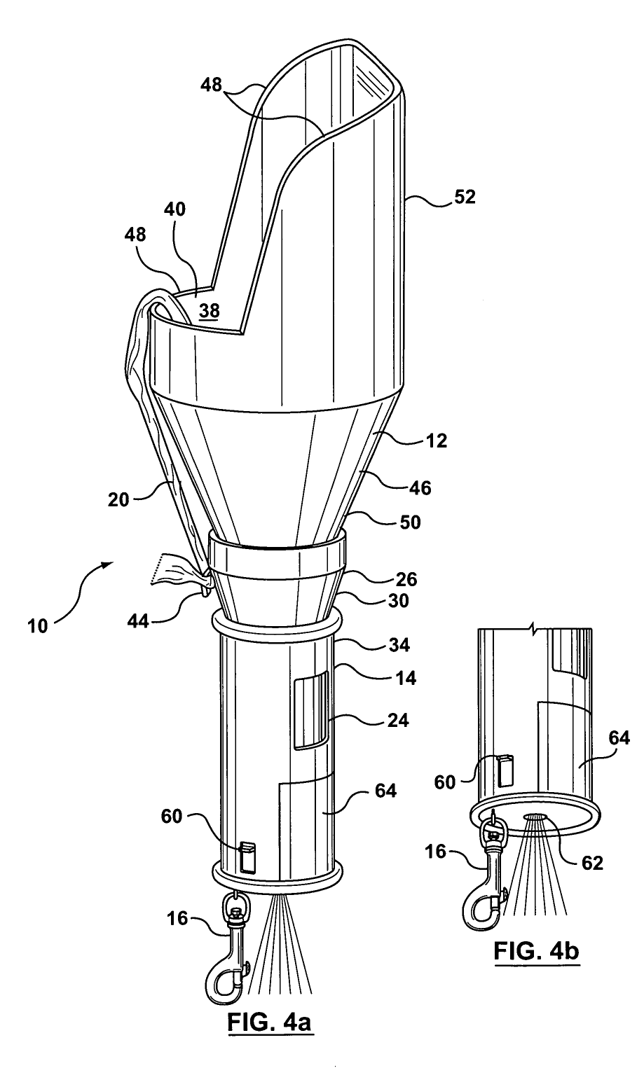

Referring to FIG. 2 or 4, the scoop 12 may have a solid or continuous surface. Referring to FIGS. 1 and 3, the scoop 12 may alternately have a discontinuous surface as in the grid-like surface shown. A mesh, perforated or other discontinuous surface may also be used. The size of the scoop 12 may vary. FIG. 1, for example, shows a small scoop 12 of about 12 cm in length with a smallest width of opening of about 10 cm. FIG. 2 shows a large scoop 12 of about 18 cm in length with a smallest width of opening of about 15 cm. Other sizes may also be used, for example a medium size between the sizes of FIG. 1 and 2, or larger or smaller sizes as appropriate for the size of the feces or other garbage to be picked up. For the purposes of this patent, the width of the opening of the scoop 12 in a selected direction is the maximum distance from one part of edge 48 to another part of edge 48 along any line extending in or parallel to the selected direction. The smallest width of opening is the smallest of the opening widths, as defined directly above, that can be obtained by selected lines extending in various directions.

The bags 20 may vary in size according to the size of the scoop 12 although a bag 20 of about 30 cm wide (i.e. across the open end of the bag 20) and about 40 cm long is adequate for both the large and small scoop 12 described above. The receptacle 14 may be a cylinder of about 5 cm in diameter and 6 cm in length which is suitable for holding a roll 22 of bags 20 of the size described above folded 4 times lengthwise before rolling to make a roughly 4 cm high roll. Such a receptacle 14 also operates as a functional yet compact handle. However, a larger receptacle 14 may also be used if a larger handle is desired and the receptacle 14 may also be more ergonomically shaped. Further optionally, a separate handle, or a handle that extends from the receptacle 14, could be used, for example a long handle that avoids having to stoop to use the scoop 12.

The scoop 12 may have any of a number of shapes that define a cavity 38. For example, but without limitation, the scoop 12 may be primarily all or a section or portion of a cylinder or three-dimensional rectilinear body or have a generally bowl-shaped portion 46. The term bowl-shaped is not intended to rigidly define any particular geometrical shape but rather to encompass a broad range of shapes defining a cavity 38 having an edge 48 defining an opening that is as wide or wider than its bottom 50. For example, the generally bowl-shaped portion 46 may be or resemble all or a portion of a whole or truncated cone, pyramid, ellipsoid, parabaloid or other concave shape. Regardless of the primary shape of the scoop 12, a section of the edge 48 may protrude or extend to form a lip 52 adapted to scrape along the ground and lever, wedge, flick or otherwise move the feces or other garbage into the cavity 38. The lip 52 may be formed, for example but without limitation, by truncating the main shape of the scoop 12 along a line skewed at an angle to a central axis of the shape or by extending all or a portion of a new shape, for example a spade or shovel type shape, from the primary shape or cavity 38 portion of the scoop 12. The passageway 36 may pass through a wall of the scoop 12 at a distance from any part of the edge 48 at least as large as the smallest width of opening of the scoop 12. The passageway 36 may also be located near the bottom 50 of the cavity 38. As illustrated, the passageway 36 may further be located generally at the bottom 50 of the cavity 38 with the axis of the coil 22 aligned to project into the cavity 38 and pass through the opening defined by the edge 48. The receptacle 14 may also be oriented along a similar alignment and may further be aligned so that its central axis passes closer to the edge 48 at the lip 52 than to any other part of the edge 48. A bag 20 pulled out of the receptacle 14 extends into the hollow of the cavity 38 from within the cavity 38 or through the wall of the scoop 12 rather than being pushed into the cavity 38 through the opening defined by the edge 48.

Referring to FIG. 4, an apparatus 10 is shown with additional elements that allow it to be used as both a flashlight and a tool for picking up feces or other garbage. In particular, a light assembly 62 is provided in a part of the receptacle 14 and adapted to shine light from the apparatus 10. The light assembly 62 is powered by batteries (not shown) which may be inserted into the apparatus 10 through a battery door 64. On/off switch 60 is electrically connected between the batteries and a bulb of the light assembly 62 and allows the bulb to be turned on and off. Other accessories, for example, but without limitation, a recoiling pet leash, could also be integrated into or connected to the apparatus 10.

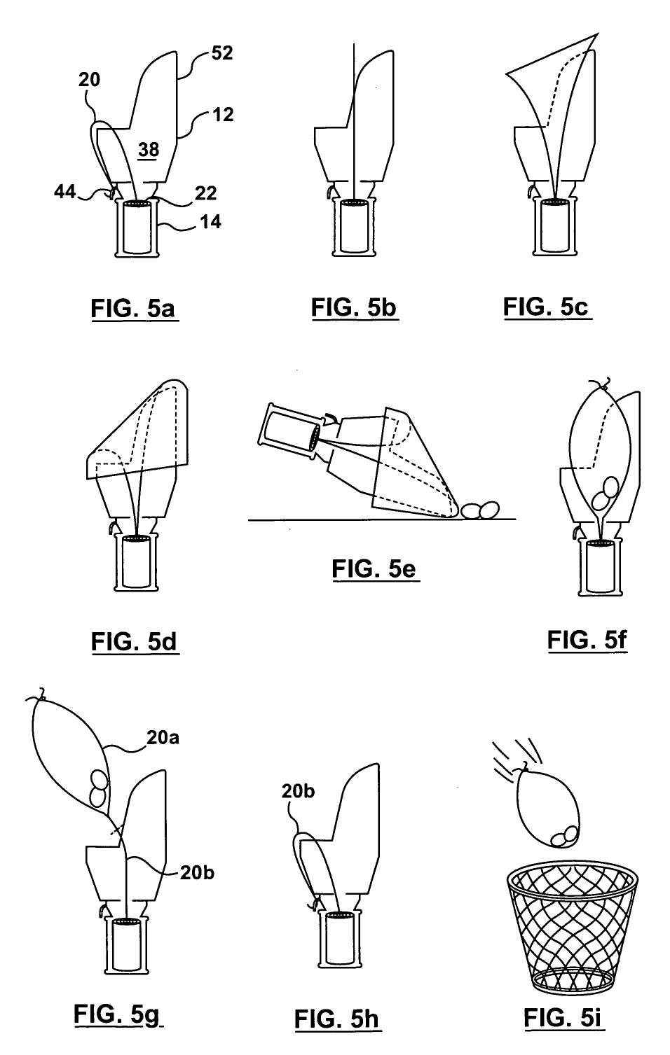

Referring to FIG. 5, a series of steps, some optional, in using a scoop 12 are shown. In part (a) a bag 20 has been pulled through the passageway 36 and its open end hooked to the hook 44 to temporarily restrain it. In parts (b), (c) and (d) the open end of the bag 20 has been spread open and folded over the edge 48 including the lip 52. The closed end of the bag 20 remains lightly held in the passageway 36 directly or because it remains attached to a following bag 20 lightly held in the passageway 36. Since the closed end of the bag is restrained by the passageway 36, folding the open end of the bag 20 over the edge 48 of the scoop 12 is easily and quickly done. Further, once folded over, the bag 20 is held at both ends by the scoop 22 and so remains in place while feces or other garbage is picked up. In part (e), the scoop 12 is run along the ground and the lip 52 passes under the feces or other garbage. The scoop 12 is then tilted so that the lip 52 points upwards causing the feces or other garbage to fall to the bottom 50 of the cavity 38 of the scoop 12. With the scoop 12 held in this position, as in part (f), the open end of the bag 20 can be folded back in from the edge 48 and tied closed. The bag 20 is then pulled out of the cavity 38 until the line of serrations appears. The bag 20 is then ripped free of the roll as in part (a). If required the first bag 20 can be hung on the hook 44 until it can be thrown away as in part (i). Alternately or additionally, the following bag 20, still in a folded and possibly twisted elongated form, can be hooked around the hook 44 as in part (h) to restrain it until it is required.

The description above is intended to describe various and preferred embodiments of the invention. However, these embodiments may be modified or other embodiments constructed or used within the teachings of the invention.

1. (canceled)

2. The apparatus of claim 4 wherein the receptacle is attached or attachable to the outside of the scoop and adapted to function as a handle.

3. (canceled)

4. An apparatus for picking up animal feces or other garbage comprising:
a) a scoop having an inside surface defining a cavity;
b) a receptacle adapted to hold a bag and attached or attachable to the scoop; and
c) a passageway connecting the interior of the receptacle with the cavity of the scoop while the receptacle is attached to the scoop
wherein the receptacle is adapted to hold a roll of detachably connected bags.
and wherein the receptacle is detachably connected to the outside of the scoop and configured such that, when detached, a coil of bags may be inserted into the receptacle from the end that connects to the scoop.

5. An apparatus for picking up animal feces or other garbage comprising:
a) a scoop having an inside surface defining a cavity;
b) a receptacle adapted to hold a bag and attached or attachable to the scoop; and
c) a passageway connecting the interior of the receptacle with the cavity of the scoop while the receptacle is attached to the scoop
wherein the receptacle is adapted to hold a roll of detachably connected bags, and
wherein the receptacle has an opening or window configured to permit a visual check on whether there are bags in the receptacle.

6. An apparatus for picking up animal feces or other garbage comprising:
a) a scoop having an inside surface defining a cavity;
b) a receptacle adapted to hold a bag and attached or attachable to the scoop;
c) a passageway connecting the interior of the receptacle with the cavity of the scoop while the receptacle is attached to the scoop; and
d) a hook adapted to hold a bag to be used or an already filled bag,
wherein the receptacle is adapted to hold a roll of detachably connected bags.

7. The apparatus of claim 4 wherein the scoop has a generally bowl shaped potion and the passageway is located within the generally bowl shaped portion.

8. The apparatus of claim 4 wherein the passageway passes through a wall of the scoop at a distance from the closest edge of the scoop, the distance being at least as large as the smallest width of opening of the scoop.

9. The apparatus of claim 4 wherein the passageway is located near the bottom of the cavity.

10. The apparatus of claim 4 wherein the receptacle extends generally perpendicularly away from the outside of the scoop.

11. The apparatus of claim 4 wherein the passageway is sized or configured to produce a mechanical or frictional resistance to a bag passing through it.

12. (canceled)

13. The apparatus of claim 4 having a protruding section of the edge of the cavity.

14. The apparatus of claim 4 wherein the inside surface of the scoop is discontinuous.

15. A device for picking up animal feces or other garbage comprising:
a) an apparatus according to claim 4; and,
b) a bag held in the receptacle.

16. The apparatus of claim 4 having a roll of bags in the receptacle.

17. The apparatus of claim 16 wherein the roll has a first end that is an open end of a first bag and a second end that is a closed end of a last bag and the bags are connected in a line with the closed end of a preceding bag connected to an openable end of a following bag.

18. The apparatus of claim 17 wherein the first end of the roll is on the inside of the roll.

19. (canceled)
